(19) United States
(12) Patent Application Publication
(10) Pub. No.: US 2008/0218159 A1
(43) Pub. Date: Sep. 11, 2008

(54) Sensor System For Determining a Position or a Rotational Speed of an Object

(75) Inventors: Michael Hinz, Hamburg (DE); Gunnar Schul-Mewes, Hamburg (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/917,095

(22) PCT Filed: Jun. 12, 2006
(86) PCT No.: PCT/IB2006/051853

§ 371 Date: Dec. 10, 2007

(30) Foreign Application Priority Data
Jun. 17, 2005 (EP) 05105391.6

(51) Int. Cl. G01P 3/487; G01B 7/30

(52) U.S. Cl. 324/207.21; 324/207.25

(57) ABSTRACT

Magnetic field sensors may be used for determination of a position or of a rotational speed of an object. According to an exemplary embodiment of the present invention, a sensor system comprises a sensor unit generating a frequency output reflecting the rotational speed or the position of the object, wherein the frequency output has a higher frequency than an encoding frequency of the object. This may provide for an improved resolution. The intrinsic sensor characteristic leads to a signal having twice or four times the frequency of the encoded magnetic field. The sensor may be a giant magneto-resistance (GMR) sensor.

The present invention relates to the field of magnetic field sensors. In particular, the present invention relates to a sensor system for determining a position or a rotational speed of an object, to a determination unit, to the use of a corresponding sensor system and to a method for determining a position or a rotational speed of an object.

A magnetic field sensor system comprises a sensor unit or sensor element and corresponding signal processing units. The sensor element, which exhibits a magneto-resistive effect, comprises a resistor bridge arranged in a Wheatstone configuration, as depicted in FIG. 1.

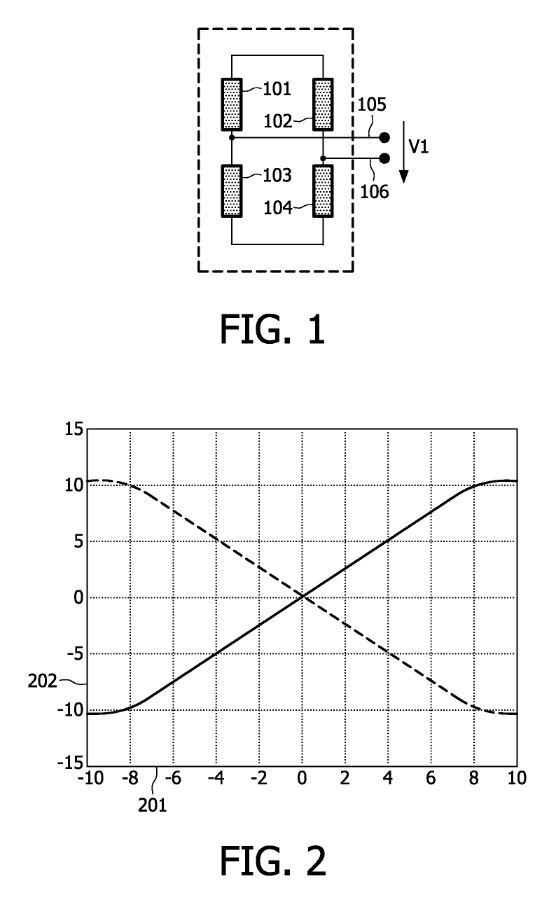

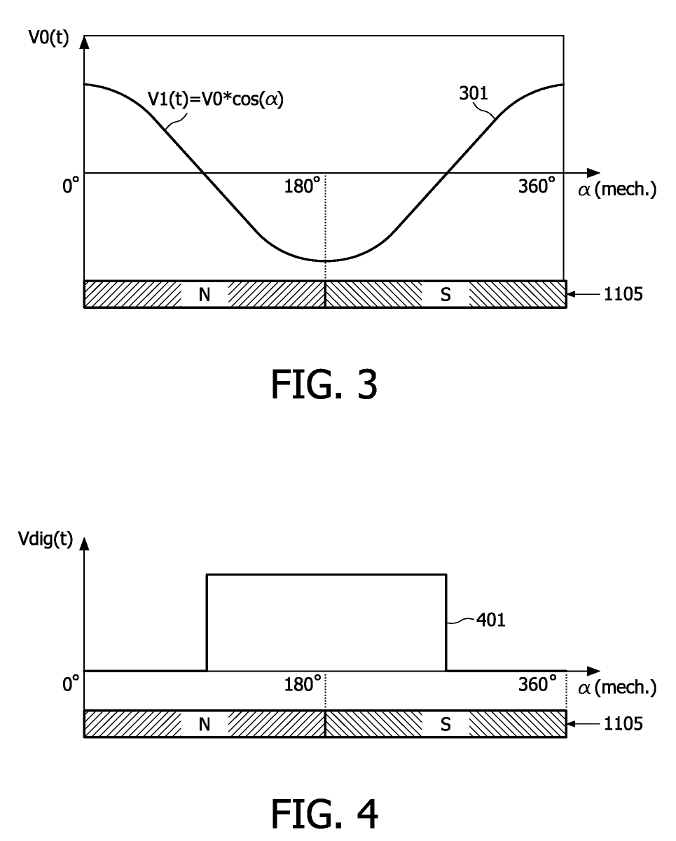

The resistance versus magnetic field strength characteristics has an S-like shape, as depicted in FIG. 2. In case of a relative movement of a magnetized encoder relative to the sensor, the sensor generates a periodical and sinusoidal output signal which has a signal period over a range of 360°, as depicted in FIG. 3. This output signal is then transmitted to a comparator which switches at each zero-crossing of the sensor signal, thereby generating a digitized signal at the output of the sensor system having the same signal frequency as the encoded signal. Consequently, the signal frequency at the system output and therefore the system resolution equals the number of magnetic pole-pairs in case of active encoders.

It may be desirable to have an improved resolution.

According to an exemplary embodiment of the present invention, a sensor system for determining a position or a rotational speed of an object may be provided, the sensor system comprising a first sensor unit and an encoder unit, wherein the encoder unit is adapted for generating an encoded magnetic field, the encoded magnetic field having a first alternating frequency, wherein the first sensor unit is adapted for measuring the encoded magnetic field and for generating a first output signal on the basis of the measured encoded magnetic field, the first output signal having a second frequency which is higher than the first frequency.

Therefore, according to this exemplary embodiment of the present invention, the sensor system generates, by means of the sensor unit, a frequency output reflecting the rotational speed of a rotating object or the position of an object (relative to the sensor unit). Furthermore, the frequency output has a higher frequency than the encoding frequency of the encoder unit (which may be integrated into the object).

This may improve the resolution of the position determination or of the determination of the rotational speed, since the output frequency is increased.

According to another exemplary embodiment of the present invention, the first sensor unit comprises a Giant Magneto Resistor (GMR). By using a giant magneto-resistance sensor (GMR sensor), a large change in resistance in response to a magnetic field may be provided. This may improve the sensitivity of the sensor system.

However, it should be noted that other technologies may be used for the sensor unit, such as, for example, anisotropic magneto-resistance (AMR) or solid-state magnetic field sensors, such as SQUID sensors (superconducting quantum interference detectors) or spin resonance magnetometers.

According to another exemplary embodiment of the present invention, the sensor system further comprises a determination unit, wherein the determination unit is adapted for generating a determination output signal on the basis of the first output signal from the first sensor unit and wherein the determination output signal represents at least one of the position and the rotational speed of the object.

According to this exemplary embodiment of the present invention, the output signal from the first sensor unit is further processed by the determination unit. For example, the determination unit may be adapted for digitizing the determination output signal on the basis of the output signal from the sensor unit. This may provide for an output signal, which may be used for an easy and secure position or rotational speed determination.

According to another exemplary embodiment of the present invention, the determination output signal has a third frequency equal or higher than the second frequency of the first sensor unit output.

Therefore, the determination unit may be adapted to even improve the resolution of the sensor unit output.

According to another exemplary embodiment of the present invention, the sensor system further comprises a second sensor unit for generating a second output signal, wherein the sensor system is adapted for generating a determination output signal on the basis of the first output signal and the second output signal. The determination output signal has a fourth frequency higher than the second frequency, wherein the determination output signal represents at least one of the position and the rotational speed of the object.

Therefore, according to this exemplary embodiment of the present invention, a plurality of sensor units may be provided, each measuring the encoded magnetic field, for example at different locations. Each sensor unit generates respective output signal. All output signals are then transmitted to the determination unit, which generates a determination output signal on the basis of the signals measured by the sensor units. This determination output signal then reflects the position or the rotational speed of the object, with a high accuracy.

According to another exemplary embodiment of the present invention, the first sensor unit has one of a V-shaped sensor characteristic and a W-shaped sensor characteristic.

This may provide for a position or rotational speed determination which is independent of a pitch. Therefore, only one magnetic field sensor may be used for different magnetized encoders with different widths of magnetic poles λ.

According to another exemplary embodiment of the present invention, a sensor for determining a position or a rotational speed of an object may be provided, the sensor comprising a determination unit and a first sensor unit, wherein the determination unit is adapted for generating a determination output signal on the basis of a first output signal from a first sensor unit, wherein the determination signal represents at least one of a position and the rotational speed of the object. The first sensor unit is adapted for measuring an encoded alternating magnetic field and for generating a first output signal on the basis of the measured encoded magnetic field, the first output signal having a second frequency which is higher than a first frequency of the encoded magnetic field.

Furthermore, according to another exemplary embodiment of the present invention, a method for determining a position or a rotational speed of an object may be provided, the method comprising the steps of: generating, by an encoder unit, an encoded magnetic field, the encoded magnetic field having a first frequency; measuring, by a first sensor unit, the encoded magnetic field; and generating, by the first sensor unit, a first output signal on the basis of the measured encoded magnetic field, the first output signal having a second frequency which is higher than the first frequency.

Thus, according to this exemplary embodiment of the present invention, a position or a rotational speed of an object may be determined by measuring an encoded magnetic field having a first alternating frequency. Changes in the encoded magnetic field are detected and processed, resulting in an output signal with a frequency at least as high as the frequency of the encoded alternating magnetic field.

This may provide for a resolution improvement without increasing the frequency of the magnetic field encoding.

Furthermore, according to another exemplary embodiment of the present invention, the method further comprises the step of generating, by a determination unit, a determination output signal on the basis of the first output signal from the first sensor unit, wherein the determination output signal represents at least one of the position and the rotational speed of the object, and wherein the determination output signal has a third frequency equal or higher than the second frequency.

It may be seen as the gist of an exemplary embodiment of the present invention that a sensor system is provided which generates, by means of a sensor unit, a frequency output reflecting the rotational speed or the position of the object, wherein the frequency output has a higher frequency than an encoding frequency of the object. Therefore, the resolution of the position or a rotational speed determination may be improved without increasing the encoding frequency.

These and other aspects of the present invention will become apparent from and elucidated with reference to the embodiment described hereinafter.

Exemplary embodiments of the present invention will be described in the following, with reference to the following drawings.

FIG. 1 shows a schematic circuit diagram of a single Wheatstone resistor bridge.

FIG. 2 shows an S-shaped magnetic field strength-bridge output characteristics of a sensor element for measuring a rotational speed.

FIG. 3 shows an output signal of the sensor element of FIG. 2.

FIG. 4 shows a digital output signal of a sensor system comprising the sensor element of FIG. 2.

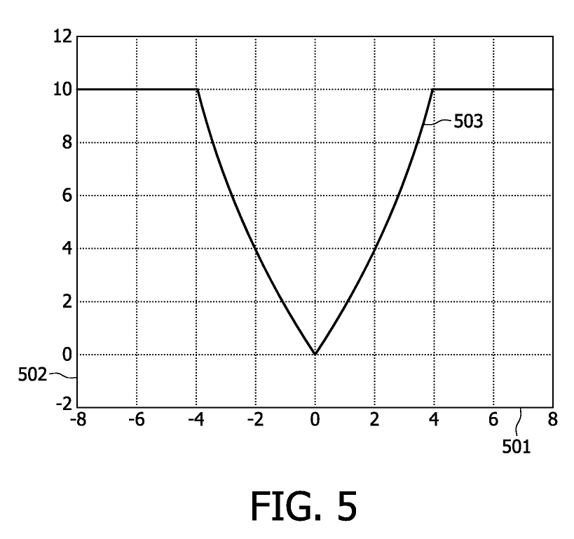

FIG. 5 shows a V-shaped characteristics of a magnetic field sensor element.

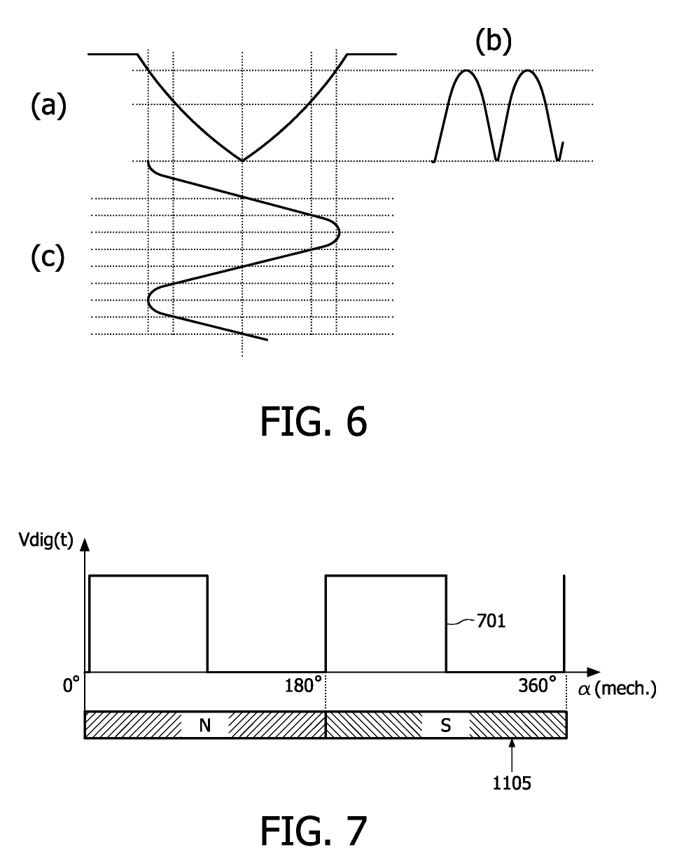

FIG. 6 shows a signal frequency duplication by means of a V-shaped characteristics according to an exemplary embodiment of the present invention.

FIG. 7 shows a digital output signal of a signal processing unit or determination unit of a magnetic field sensor system having a V-characteristics according to an exemplary embodiment of the present invention.

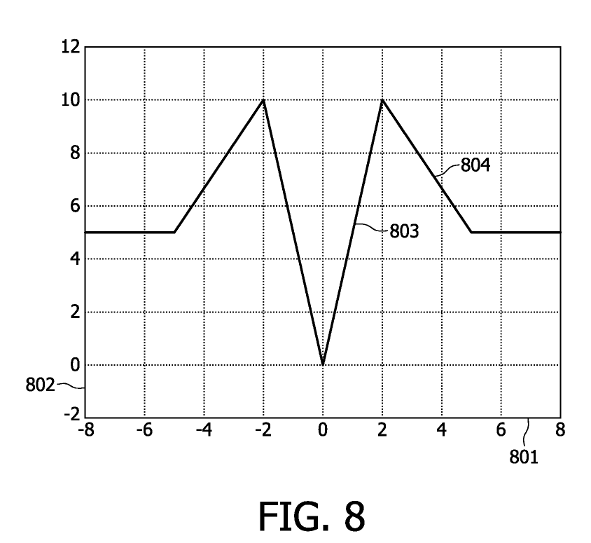

FIG. 8 shows a W-shaped characteristics of a magnetic field sensor element according to an exemplary embodiment of the present invention.

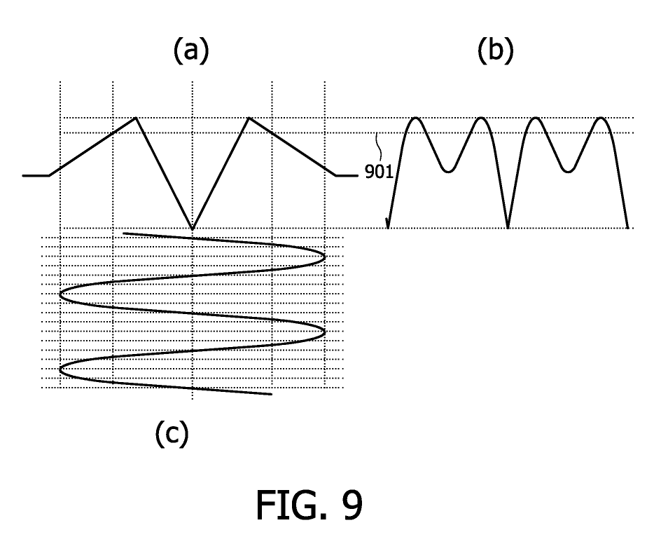

FIG. 9 shows a signal frequency multiplication of a W-shaped characteristics according to an exemplary embodiment of the present invention.

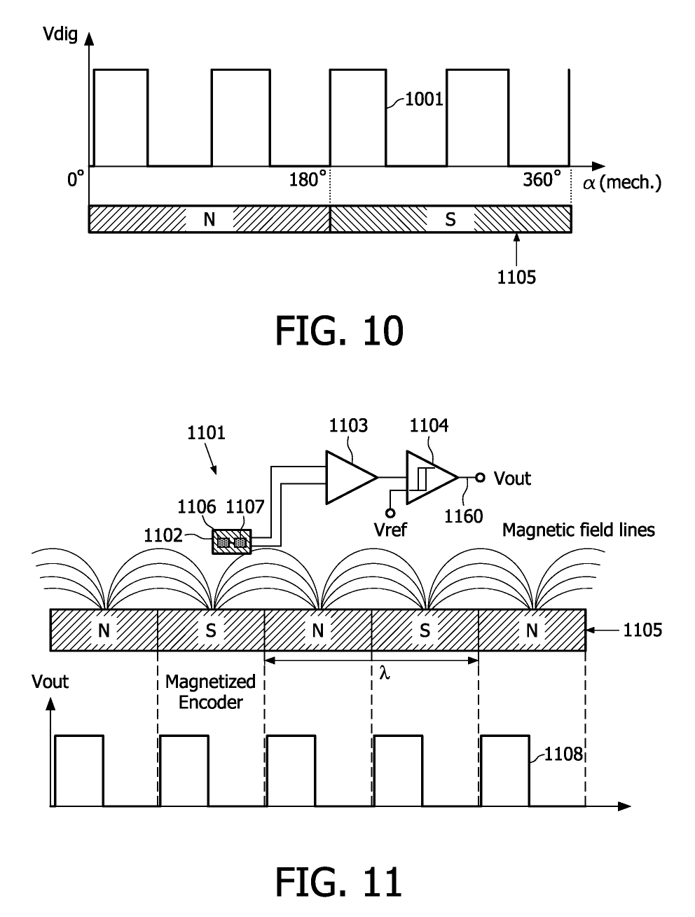

FIG. 10 shows a digital output signal of a signal processing unit of a magnetic field sensor system having a W-characteristics according to an exemplary embodiment of the present invention.

FIG. 11 shows a magnetic field sensor system for position determination of a linearly shaped object on the basis of a comparator circuit according to an exemplary embodiment of the present invention.

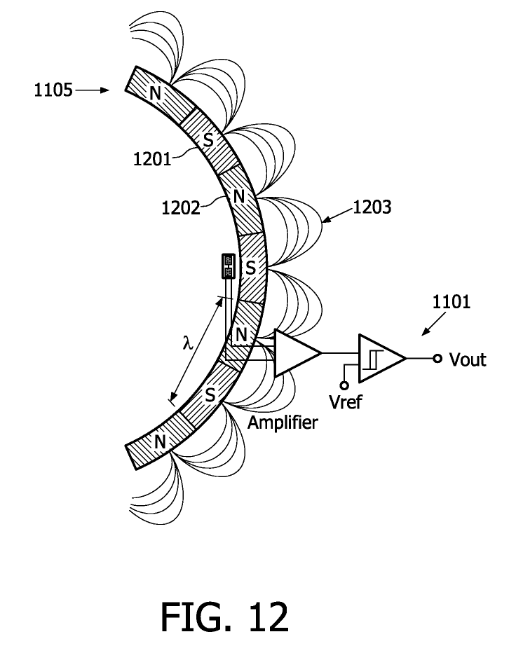

FIG. 12 shows an exemplary measuring setup of rotational frequencies of a rotating encoding unit according to an exemplary embodiment of the present invention.

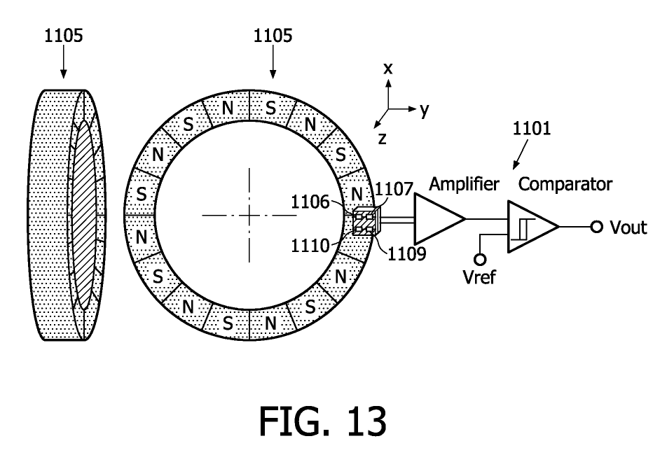

FIG. 13 shows an exemplary application for measuring a rotational speed of an actively magnetized rotating encoder according to an exemplary embodiment of the present invention.

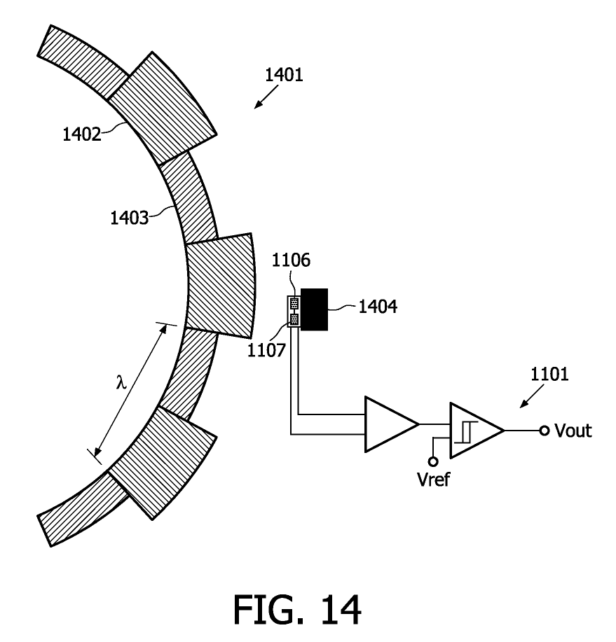

FIG. 14 shows a measurement setup for measuring rotational frequencies of a passive encoder according to an exemplary embodiment of the present invention.

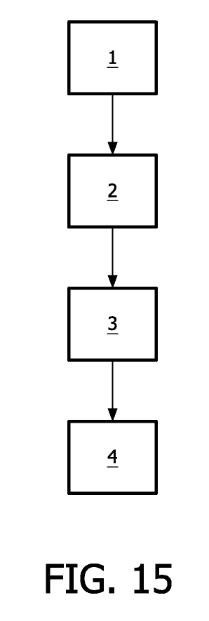

FIG. 15 shows a flow-chart of an exemplary method of an exemplary embodiment of the present invention.

The illustration in the drawings is schematically. In different drawings, similar or identical elements may be provided with the same reference numerals.

FIG. 1 shows a schematic circuit diagram of a single Wheatstone resistor bridge, comprising four resistors 101, 102, 103, 104 and corresponding circuitry 105, 106. Arranging the resistor elements in form of a Wheatstone bridge may provide for a temperature compensation and a generation of a differential signal, which is easy to analyze. However, even a single resistive element may be used for measuring a magnetic field or magnetic field changes.

By the effect of an external magnetic field H the resistivity of the resistive elements 101-104 may be changed and the resulting output signal of the full bridge (V1) is a function of the magnetic field H.

FIG. 2 shows the output signal characteristics of such a sensor element of FIG. 1. The R-H-characteristics shows an S-shaped dependency. The horizontal axis 201 depicts the magnetic field strength H in units kA/m and the vertical axis 202 depicts the bridge output U in units mV/V. The differential output voltage of the bridge arrangement has a negative sign in the region of negative magnetic field strength H and a positive sign in the region of positive magnetic field strength H.

The encoders, according to an exemplary embodiment of the present invention, may be active encoders or passive encoders. Active (or magnetized) encoders may comprise a lateral alternating magnetized layer comprising an alternating sequence of north poles and south poles, generating an alternating magnetic field when moved relative to the magnetic field sensor unit (in the region of the sensor unit). In case of an magnetized encoder the region of 360° corresponds to a north-south-pole pair of the magnetized layer and therefore to the pole pair width λ (λ=360°).

Such an active encoder is, for example, depicted in FIG. 11 (reference sign 1105).

Furthermore, passive encoders may be used, such as the one depicted in FIG. 14 (reference numeral 1401).

Such a passive or ferromagnetic encoder may comprise an alternating sequence of tooths and gaps 1402, 1403, respectively. In case of a passive encoder, a working magnet 1404 has to be employed, which may be arranged on the back side of the sensor units 1106, 1107.

The magnetic field generated by the working magnet (which is not depicted in the figures) penetrates the resistors 101-104 of the magnetic field sensor element 1102. When the passive encoder 1401 moves relatively to the magnetic sensor 1102, the position of a tooth 1402 or a gap 1403 relative to the sensor element 1102 changes. Therefore, the resistance values of the magnetic field sensor elements 1106, 1107 change correspondingly and generate a sinusoidal output signal.

Encoders may be implemented in form of a linear encoder 1105 for measuring linear movements and linear distances or in form of an encoded wheel 1401 for measuring rotational frequencies. However, the resolution of the measurement may depend on the characteristics of the sensitive elements and on the number of resistor bridges used.

For measuring rotational frequencies the interfaces between the magnetic north and south poles may be used for zero-crossing detection. For example, comparator circuits may be provided for signal processing, which generate digital information on the basis of analogue input signals, the digital information being provided at the system output. The digital information may then be further analyzed by an electronic determination unit.

Such rotational speed sensors may be used for breaking systems in automotive applications having an ABS-functionality.

With the help of a known number of magnetic field north and south poles the rotational speed may be determined on the basis of the zero-crossing signals. According to known methods, the frequency of the digital output signal equals the frequency of the encoder. In other words, having ten magnetic north poles and ten magnetic south poles arranged along a circumference of an encoded wheel, a full rotation of the encoded wheel results in ten consecutive sinus curves.

FIG. 3 shows an output signal of the sensor element of FIG. 2. In case of a relative movement of the magnetized encoder relative to the sensor (which has an S-shaped characteristics) a periodical and sinusoidal output signal 301 is generated, which has a signal period over a range of 360°. The output signal of the sensor element may be fed into a comparator circuitry, which may switch during the zero-crossings of the sensor output signals and which may generate a digital signal at the system output which has the same signal frequency as the sinus signal of the sensor element depicted in FIG. 3. This digitized signal of a sensor system comprising the sensor element of FIG. 2 is depicted in FIG. 4 (reference numeral 401).

Therefore, the signal frequency may depend on the number of magnetic poles in case of active encoders.

In case of encoders which have a compact size, the position or rotational speed determination may lead to a low quality result, since the encoders exhibit a limited field strength. This limited field strength may not be sufficient for accurate measurements at comparatively high distance from the encoder.

It may therefore be desirable to provide for an improved resolution by increasing the frequency characteristics of the sensor system.

For improving the resolution of a position or rotational speed measurement of an encoder moving relatively to the sensor, the signal frequency may have to be increased. For sensors, which have an S-shaped characteristics, the signal frequency may correspond to the number of magnetic poles of the encoder, i.e. a signal period corresponds to a pole pair width or 360°.

In order to achieve a frequency multiplication, the sensor characteristics of a magnetic field sensor has to be changed. This may provided, for example, by a V-shaped or by a W-shaped characteristics. Due to manifold characteristics of different magnetic field sensors two or more signal periods may be generated over a range of 360°.

FIG. 5 depicts a V-shaped characteristics of a magnetic field sensor element, for example a GMR sensor element. Horizontal axis 501 depicts the magnetic field strength H in units kA/m and the vertical axis 502 represents the bridge output Uₒᵤₜ in units mV/V. As may be seen from FIG. 5, the GMR Wheatstone bridge output 503 is V-shaped. The Wheatstone bridge output of the sensor unit may be transmitted to a determination unit used for signal analysis or signal processing. As may be seen from FIG. 5, the differential signal of the sensor element has basically always the same absolute value independent of the direction of the magnetic field. Therefore, the characteristics 503 is ambitious with respect to the output voltage.

FIG. 6 shows, how the frequency duplication is achieved by the V-shaped characteristics of the sensor unit, if the sensor unit is excited by a sinusoidal magnetic field. FIG. 6c shows the input signal, which is the sinusoidal magnetic field. The horizontal axis of FIG. 6c represents the magnetic field strength and the vertical axis of FIG. 6c represents for example a rotational angle, a time, or a location.

FIG. 6a depicts the V-shaped characteristics of the sensor unit. Again, the horizontal axis represents the magnetic field strength and vertical axis represents the sensor output.

FIG. 6b shows the output signal of the sensor unit, if signal 6c is measured. Here, the horizontal axis represents the vertical axis of FIG. 6c (angle, time, or location) and the vertical axis represents the sensor output. As may be seen from FIG. 6b, the sensor output has twice the frequency of the input signal depicted in FIG. 6c.

As depicted in FIG. 7, the output signal depicted in FIG. 6b may be further processed into a digitized output signal by a determination unit of the magnetic field sensor system. As may be seen from FIG. 7, the digitized output signal 701 now has twice the frequency of the digitized output signal of FIG. 4.

FIG. 8 shows a W-shaped characteristics of a magnetic field sensor element according to an exemplary embodiment of the present invention. This W-shaped characteristics may be used for frequency multiplication (according to the use of the V-shaped characteristics depicted in FIG. 5). As may be seen from FIG. 8, in which the horizontal axis 801 represents the magnetic field strength H in units kA/m and in which the vertical axis 802 represents the bridge output Uₒᵤₜ in units mV/V (axis 801 ranging from −8-8 kA/m and axis 802 ranging from −2-12 mV/V). The output signal increases with increasing magnetic field strength followed by a decrease of the output signal with further increasing magnetic field strength 803, 804, respectively. The ambiguity of the characteristics depicted in FIG. 8 with respect to the output voltage is the basis for the following frequency multiplication.

FIG. 9 shows a signal frequency multiplication on the basis of a W-shaped characteristics according to an exemplary embodiment of the present invention. FIG. 9c shows the sinusoidal magnetic field dependency as input signal, wherein the horizontal axis represents the magnetic field strength H and the vertical axis represents one of a rotational angle, a time, or a location (of the sensor with respect to the encoder).

FIG. 9a shows the W-characteristics of a sensor unit (as the one depicted in FIG. 8).

FIG. 9b shows the output signal of the sensor unit measuring the signal of FIG. 9c. As may be seen from FIG. 9b, in which the horizontal axis represents angle, time, or location and the vertical axis represents the sensor output signal, a frequency multiplication by a factor of four (with respect to standard sensor systems) has been achieved. This frequency multiplication may be achieved by adjusting a trigger point or switching point of a following signal processing step, as depicted by horizontal line 901. This means, that four signal periods are present over a range of one magnetic pole pair (360°).

Therefore, it is possible, without additional electronic expenditure, to provide for a multiplication of the output signal by using a sensor unit according to an exemplary embodiment of the present invention (such as GMR sensor unit).

The frequency multiplication of the digital output signal, generated by a signal processing of the sensor unit output signal of FIG. 9b is depicted in FIG. 10 by signal 1001.

Furthermore, according to an exemplary embodiment of the present invention, a plurality of sensor units may be used for frequency increase or frequency multiplication of the measured signals. For example, a first sensor unit, such as sensor unit 1106 of FIG. 11, may be positioned at a first location and a second sensor unit, such as sensor unit 1107 of FIG. 11, may be positioned at a second location in the GMR sensor system 1101.

Each sensor unit 1106, 1107 outputs a respective output signal reflecting magnetic field changes during relative movement of the encoder 1105 and the sensor 1102. The two output signals are then amplified by amplifier 1103 and processed by comparator 1104, which is provided with a reference voltage V_{ref}. Then, by signal output 1160, a determination output signal Vₒᵤₜ is provided as signal 1108. This determination output signal 1108 represents at least one of the position and the rotational speed of the object or encoder 1105. In case of FIG. 11, the encoder 1105 is a linearly shaped object which position is measured by the sensor system 1102.

By using a plurality of single sensor units 1106, 1107 a further increase of signal frequency may be provided.

Furthermore, a further increase of signal output frequency may be provided by signal processing techniques carried out by a comparator or further electronics 1104.

It should be noted that other sensor units may be used, which exhibit different transfer characteristics than V-shaped or W-shaped transfer characteristics.

FIG. 12 shows a measurement setup for measuring rotational frequencies of a rotating object comprising an encoding unit 1105. The encoding unit 1105 is magnetically coded, for example, by regions of alternating magnetization 1201, 1202. This is symbolized by magnetic field lines 1203. The measurement performed by the sensor system 1101 is performed on the outer circumference of the encoding unit 1105.

Another exemplary measurement setup for measuring a rotational speed is depicted in FIG. 13. Here, the magnetic sensor system 1101 performs a magnetic field measurement at the front surface of the encoder 1105.

FIG. 14 shows another exemplary embodiment of a measurement setup according to the present invention for measuring rotational frequencies at the outer circumference of a passive ferromagnetic encoder 1401. The encoder 1401 comprises a plurality of tooth 1402 and gaps 1403, as described above. The GMR-sensor system 1101 comprises a working magnet 1404 arranged at the back side of the sensor units 1106, 1107.

FIG. 15 shows a flow-chart of an exemplary embodiment of an exemplary method according to the present invention. The method starts at step 1 by generating an encoded magnetic field having a first frequency. This encoded magnetic field may be generated by an encoder unit which is coupled or which forms part of the object to be tracked. In a second step, the encoded magnetic field is measured by a first sensor unit and may be measured by a second sensor unit (however, the second sensor unit is not necessary according to an exemplary embodiment of the present invention!), while the object (and the encoder unit) moves relatively to the sensor unit, for example by a rotating movement or by a linear movement, or any other movement.

After measuring the corresponding magnetic field changes by the sensor units, first and second output signals are generated, corresponding to the magnetic field changes. Both output signals have frequencies which are higher than the frequency with which the magnetic field changes (due to movement of the encoder relative to the sensor).

In a fourth step, a determination output signal is generated by a determination unit, which may be a comparator or some other analyzing or processing unit and which may be implemented, for example, in form of an integrated circuit or other electronic elements. The generated determination output signal has a frequency which is higher than the frequency with which the magnetic field changes due to rotation or other movement of the encoder. Therefore, the resolution of the position or rotating frequency measurement is improved.

This frequency increasing property of the magnetic field sensor provides for an application of the magnetic field sensor for rotational speed measurements and position determination by means of small magnetized encoders. The exemplary embodiments depicted in FIGS. 11-14 may be implemented using different encoder embodiments and corresponding electronic signal processing for position and rotational speed determination.

Decreasing the size of the encoders may be necessary in applications such as automotive applications for wheel bearings.

When reducing the size of an encoder, the effective magnetic field strength H may be reduced correspondingly. Thus, for example, the distance between the sensor and the encoder has to be reduced in order to provide for a constant resolution. If such a reduction is not possible, the resolution of the measurement decreases. In order to improve the resolution, frequency increasing methods according to exemplary embodiments of the present invention may be used.

According to an aspect of the present invention, a frequency increase is provided inside the sensor unit without the necessity of using additional electronic components or mechanical components.

By increasing the output frequency of the measured signal according to an exemplary embodiment of the present invention, the electronic analyzation circuitry for analyzing the measurement signal may be simplified in case of interpolation methods. For example, if a sinusoidal sensor output signal is transmitted to an interpolator which interpolates with a factor of 256 or 8 bit, the factor may be reduced to 128 by frequency duplication according to the present invention. The reduction of the interpolation factor may result in a considerable cost reduction and a reduction of required space for the electronic components.

Furthermore, the reliability of the sensor system may be increased, since the increase of output frequency may lead to a reduction of electronic components and therefore to a simplification of the analyzation and processing circuitry. This may be of particular interest for the automotive industry.

It should be noted that the term “comprising” does not exclude other elements or steps and the “a” or “an” does not exclude a plurality and that a single processor or system may fulfill the functions of several means or units recited in the claims. Also elements described in association with different embodiments may be combined.

It should also be noted, that any reference signs in the claims shall not be construed as limiting the scope of claims.

1. A sensor system for determining a position or a rotational speed of an object, the sensor system comprising:
a first sensor unit;
an encoder unit;
wherein the encoder unit is adapted for generating an encoded magnetic field, the encoded magnetic field having a first alternating frequency;
wherein the first sensor unit is adapted for measuring the encoded magnetic field and for generating a first output signal on the basis of the measured encoded magnetic field, the first output signal having a second frequency which is higher than the first frequency.

2. The sensor system of claim 1,
wherein the first sensor unit comprises a Giant Magneto Resistor.

3. The sensor system of claim 1,
further comprising a determination unit;
wherein the determination unit is adapted for generating a determination output signal on the basis of the first output signal from the first sensor unit; and
wherein the determination output signal represents at least one of the position and the rotational speed of the object.

4. The sensor system of claim 3,
wherein the determination output signal has a third frequency equal or higher than the second frequency.

5. The sensor system of claim 3, further comprising a second sensor unit for generating a second output signal;
wherein the sensor system is adapted for generating a determination output signal on the basis of the first output signal and the second output signal;
wherein the determination output signal has a fourth frequency higher than the second frequency;
wherein the determination output signal represents at least one of the position and the rotational speed of the object.

6. The sensor system of claim 1,
wherein the first sensor unit has one of a V-shaped sensor characteristic and a W-shaped sensor characteristic.

7. A sensor for determining a position or a rotational speed of an object; the sensor comprising a determination unit and a first sensor unit;
wherein the determination unit is adapted for generating a determination output signal on the basis of a first output signal from a first sensor unit; and
wherein the determination output signal represents at least one of the position and the rotational speed of the object;
wherein the first sensor unit is adapted for measuring an encoded alternating magnetic field and for generating a first output signal on the basis of the measured encoded magnetic field, the first output signal having a second frequency which is higher than a first frequency of the encoded magnetic field.

8. The sensor of claim 7,
wherein the determination output signal has a third frequency equal or higher than the second frequency.

9. The sensor of claim 7,
further comprising a second sensor unit for generating a second output signal;
wherein the determination unit is adapted for generating a determination output signal on the basis of the first output signal from a first sensor unit and a second output signal from a second sensor unit;
wherein the determination output signal has a fourth frequency higher than the second frequency;
wherein the determination output signal represents at least one of the position and the rotational speed of the object.

10. Use of a sensor system of claim 1 for determining a position or a rotational speed of an object.

11. Method for determining a position or a rotational speed of an object, the method comprising the steps of:
generating, by an encoder unit, an encoded magnetic field, the encoded magnetic field having a first alternating frequency;
measuring, by a first sensor unit, the encoded magnetic field;
generating, by the first sensor unit, a first output signal on the basis of the measured encoded magnetic field, the first output signal having a second frequency which is higher than the first frequency.

12. The method of claim 11, further comprising the step of:
generating, by a determination unit, a determination output signal on the basis of the first output signal from the first sensor unit;
wherein the determination output signal represents at least one of the position and the rotational speed of the object, and
wherein the determination output signal has a third frequency equal or higher than the second frequency.

13. The method of claim 11, further comprising the step of:
generating, by the sensor system, a determination output signal on the basis of the first output signal from the first sensor unit and a second output signal from a second sensor unit;
wherein the determination output signal has a fourth frequency which is higher than the second frequency;
wherein the determination output signal represents at least one of the position and the rotational speed of the object.
